(19) United States
(12) Patent Application Publication
(10) Pub. No.: US 2011/0165448 A1
(43) Pub. Date: Jul. 7, 2011

(54) Tube Sheet for a Lead Acid Battery

(75) Inventors: Friedrich Kramm, Budingen (DE); Hubert Wittmann, Tannesberg (DE)

(73) Assignee: EXIDE TECHNOLOGIES GMBH, Büdingen (DE)

(21) Appl. No.: 12/997,917

(22) PCT Filed: Jul. 14, 2009
(86) PCT No.: PCT/EP09/58999

§ 371 Date: Dec. 14, 2010

(30) Foreign Application Priority Data
Jul. 25, 2008 (DE) 10 2008 034 587.3

(51) Int. Cl. H01M 2/18

(52) U.S. Cl. 429/140

(57) ABSTRACT

The present invention concerns a tube plate for an electrode, preferably a positive electrode, of a lead acid battery, wherein the tube plate (2) has an upper frame (3) and a plurality of lead or lead alloy cores (1) extending substantially parallel from the upper frame (3). To provide a tube plate for an electrode of a lead acid battery, with which a lower current density and shorter current paths or diffusion paths for reducing the electrical resistance in comparison with tube plates in accordance with the state of the art are achieved, with the same use of material, it is proposed according to the invention that in the cross-section relative to their longitudinal extent the cores (1) have a surface profile with at least three convex portions (11) and at least three concave portions (12), wherein convex and concave portions (11, 12) alternate in the course of the surface profile.

The present invention concerns a tube plate for an electrode, preferably a positive electrode, of a lead acid battery, wherein the tube plate has an upper frame and a plurality of lead or lead alloy cores extending substantially parallel from the upper frame.

Primarily grid plates and tube plates are used as electrodes in lead acid batteries. Grid plates can be used both as the negative and also as the positive electrode plates whereas tube plates can only be used as positive electrode plates. Tube plates comprise a plurality of cores which are arranged substantially parallel in mutually juxtaposed and equidistant relationship and which are all secured to a bridging portion, the so-called upper frame, and extend therefrom. The upper frame has a lug which projects therefrom and by way of which, in a lead acid battery, the electrode plates of the same polarity are connected together. The tube plate comprising the upper frame, the lug and the cores is made from lead or lead alloy, preferably from a lead-tin-calcium alloy or a lead-antimony-alloy.

The entire electrode plate further includes a so-called tube pocket with a number, corresponding to the number of cores, of mutually juxtaposed tubes of substantially circular cross-section and of a length which is greater than the length of the cores. Usually the tube pocket comprises a textile material, preferably a textile woven material or non-woven material. For assembly and finishing of the electrode plate the cores are introduced into the tube portions of the tube pocket. To ensure that the cores are arranged as far as possible centrally in the tube portions of the tube pocket so that in operation diffusion paths which are as uniform as possible from the tube portions to the surface of the cores are guaranteed, the cores generally have spacers (blades) which extend from the cores perpendicularly in a plurality of directions to the inside walls of the tube portions of the tube pocket.

The cavity in the tube pocket between the core and the inside wall of the tube portion is filled with active material, usually a paste of lead oxide, sulfuric acid and water. Earlier lead dust or red lead oxide was used instead of lead oxide. To prevent the active material from running out of the tube pocket the openings of the tube portions, that are opposite to the upper frame, are frequently still closed with a closure bar.

The cores of the tube plates for lead acid batteries in the state of the art are usually of a circular cross-section whereby the core, with respect to the cross-sectional area or the use of material, is of the smallest possible periphery and thus the smallest possible surface area for the core. That circular cross-sectional shape of the cores has been used for decades. The core profile is easy to produce using a die casting process with divided molds and can be readily handled. Other profiles such as for example oval cross-sections of cores or tube pockets have not proven successful.

The circular geometry of the cores has proven its worth for many years, and for that reason there was also hitherto no cause to depart therefrom. The inventors of the present application however have discovered that improvements can be achieved with cross-sectional profiles for such cores, other than the long-standing circular ones.

It is known that the current density at the core becomes correspondingly higher, the smaller the surface area of the core. A high current density at the core worsens utilization of the positive material. It is further known that the efficiency of an electrode plate is poor if the spacing from the surface of the core to the outside surface of the active material (=diffusion path or current path) is great as long diffusion paths or current paths lead to a high electrical and diffusion resistance and thus a high voltage loss. The smaller the spacing between the core and the outside surface of the active material, the correspondingly greater is the efficient utilization and performance of the electrode plate.

Hitherto the reduction in current density and the reduction in the length of the current paths through the active material has been simply achieved by making the diameter of the core larger or adopting an oval cross-section, whereby it was possible to achieve a larger area for the core and thus a lower level of current density and an increase in the utilization of positive material. At the same time it was possible in that way to shorten the current paths from the surface of the core to the outside surface of the active material, which is defined by the diameter of the tube portions of the tube pocket, and thus reduce the resistance and voltage losses. The solution applied hitherto is simple but because of the thicker cores it requires more lead or lead alloy, which in more recent times with increasing raw material costs represents a cost factor which is becoming ever increasingly significant. A further disadvantage of increasing the diameter of the core to reduce the current density and shorten the current paths is that the space between the core and the inside wall of the tube portions becomes smaller and can accommodate less active material, whereby the capacity of the lead acid battery is reduced, in spite of a high power density.

The object of the present invention was that providing a tube plate for an electrode of a lead acid battery, with which the aforementioned disadvantages of the state of the art are improved and with which a reduction in current density and shorter current paths or diffusion paths for reducing the electrical resistance in comparison with tube plates in accordance with the state of the art are achieved, using the same material.

That object is attained by a tube plate of the kind set forth in the opening part of this specification, which is characterized in that in the cross-section relative to their longitudinal extent the cores have a surface profile with at least three convex portions and at least three concave portions, wherein convex and concave portions alternate in the course of the surface profile.

The cross-sectional profile of the cores of the tube plate according to the invention differs from a circular shape and therefore involves a larger periphery in comparison with a core of circular cross-section and with the same cross-sectional area or the same use of material. A larger periphery means that the core has a larger area over its length, which in turn leads to a reduction in the current density and an increase in the utilization of positive material, in use of the battery. In addition a larger area for the core offers a larger contact area between the active material and the core surface, which advantageously results in a lower electrical transfer resistance.

The configuration according to the invention of the cross-sectional profile of the cores means that, in comparison with a circular cross-sectional profile involving the same cross-sectional area and the same material use, a larger periphery is achieved and therewith a larger area for the cores, which is advantageous for current density. In that way it is possible to achieve better positive material utilization. If the cores are considered from the point of view of utilization of material and surface area, the invention has the advantage that, in comparison with a core of circular cross-sectional profile with the same area and the same utilization of material, a smaller cross-sectional area and thus a lower use of material is required, whereby considerable raw material costs can be saved.

In accordance with the present invention convex portions of the surface profile in cross-section of the cores mean that the curvature of the surface is curved from the interior of the core outwardly. In other words, this means that the center points of the radii of the convex portions in the core material are in the interior of the cores. Conversely in accordance with the invention concave portions of the surface profile mean that the surface of the core is curved inwardly in such a portion towards the interior of the core, in other words the center points of the radii of curvature of those portions generally lie outside the core material.

The definition of the present invention that the cores in cross-section relative to their longitudinal extent have a surface profile with at least three convex portions and at least three concave portions does not necessarily signify that the surface profile consists exclusively of alternating convex or concave portions. The present invention also includes straight portions also being provided between convex and concave portions in the course of the surface profile. In other words, between a convex portion and a concave portion the surface profile can assume a straight configuration, that is to say neither convex nor concave.

In addition the invention is also intended to embrace the aspect that straight portions can be provided within individual convex or concave portions in the course of the surface profile. In other words that means that a convex or a concave portion can have within that portion a straight, that is to say uncurved, surface portion. It can also be so expressed that a convex portion goes into a straight portion and then into a convex portion again, or a concave portion goes into a straight portion and then into a concave portion again.

Expressed in accordance with the invention a circular, oval or elliptical surface profile in the cross-section of the core is a profile having or consisting of a single convex portion.

According to the invention however the surface profile has at least three convex portions and at least three concave portions, wherein convex and concave portions alternate in the course of the surface profile. In accordance with the invention a plurality of different convex portions, for example with different radii of curvature, when they follow in immediate succession or have straight portions between them, but do not have therebetween a concave portion, are deemed to be a single convex portion in accordance with the present invention. The same also applies conversely for concave portions.

In an embodiment of the invention the surface profile of the cores has 3 through 8 convex portions and 3 through 8 concave portions. Preferably the surface profile has 3 through 5 convex portions and 3 through 5 concave portions and quite particularly preferably the surface profile has four convex and four concave portions which alternate in the course of the surface profile.

In the particularly preferred embodiment of the present invention having four convex and four concave portions the core thus has a substantially “cross-shaped” surface profile in the cross-section in relation to its longitudinal extent.

In an embodiment of the invention all convex portions are of the same radius or involve the same radius configuration in the course of the surface profile and/or all concave portions have the same radius or the same radius configuration in the course of the surface profile.

A convex or concave portion can have precisely one radius of curvature before the surface profile goes into a straight or oppositely curved portion, that is to say from convex to concave or vice-versa. Alternatively a convex or concave portion however may also have a plurality of different radii within a portion, that is to say the radius of curvature changes in the course of a convex or concave portion without the direction of curvature changing from convex to concave or vice-versa. In an embodiment in which all convex portions have the same radius or the same radius configuration and all concave portions have the same radius or the same radius configuration, wherein the radius or radius configuration of the convex portions does not have to be the same as that of the concave portions, the surface profile of the cores in cross-section is rotationally symmetrical about the longitudinal axis of the core.

In a further embodiment of the invention all convex portions in the course of the surface profile have precisely one radius and/or all concave portions in the course of the surface profile have precisely one radius. That means that, within a convex or concave portion, there is no change in the radius of curvature until that portion goes into a straight or oppositely curved portion.

In a further embodiment of the invention the concave portions in the course of the surface profile have the same radius or the same radius configuration as the concave portions, but in the opposite direction of curvature.

In a quite particularly preferred embodiment of the invention all convex portions in the course of the surface profile have the same radius or the same radius configuration and all concave portions in the course of the surface profile have the same radius or the same radius configuration and the convex portions and concave portions are respectively in mirror-image symmetrical relationship in themselves. If a convex or concave portion has precisely one radius of curvature and has no straight portions within the convex or concave portion it is necessarily in mirror-image symmetrical relationship. A radius configuration with a curvature which changes within a portion, that is to say a plurality of changing radii in a portion, it is then in mirror-image symmetrical relationship in itself if the succession of the radii of curvature within the overall portion and the length of the subportions of such radii are symmetrical. Examples would be portions having the following radius arrangement: R1-R2-R1, R1-R2-R3-R2-R1, R1-R2-straight portion-R2-R1 etc.

In a further embodiment of the invention the radii of the convex and concave portion of the surface profile of the cores are in the range of between 0.1 and 1.5 mm, preferably between 0.2 and 1.1 mm, further preferably between 0.3 and 0.9 mm, particularly preferably between 0.4 and 0.8 mm.

As already stated hereinbefore the substantially parallel cores are secured to the upper frame of the tube plate or merged thereinto as they are usually produced in one piece with each other from the same material. In a preferred embodiment of the invention the transitions from the upper frame to the cores are respectively formed by portions which extend initially cylindrically from the upper frame and taper conically towards the cores.

To finish the electrode plate the cores are introduced into parallel mutually juxtaposed tube portions of a tube pocket of substantially circular cross-section. Then the active material is introduced between the cores and the inside wall of the tube portions of the tube pocket. Preferably the tube portions of the tube pocket are of a diameter which corresponds substantially to the diameter of the portions extending cylindrically from the upper frame so that the tube portions of the tube pocket can be brought into engagement in substantially force-locking relationship with the cylindrical portions. That ensures that the tube pocket is in a relatively firm fit in connection with tube plate. The tube pocket is desirably made from a textile material, preferably from textile woven material, which however is known from the state of the art for conventional tube plates.

The present invention also embraces a lead acid battery with tube plates of the kind according to the invention as described herein.

As already stated hereinbefore the advantages of the present invention are an increase in the surface area of the cores, that comes into contact with the active material, thereby providing a reduction in the current density at the core and an increase in the positive utilization of material.

For example, a cross-shaped profile for the core having four convex and four concave portions of the surface profile, which are all of the same radius, provides an increase in the surface area by about 20% with respect to a circular surface profile. At the same time, with such a surface profile according to this invention, in comparison with a core of circular surface profile and of the same cross-sectional area, the mean current path or diffusion path from the surface of the core through the active material to the inside wall of the tube portions of the tube pocket is reduced.

In accordance with the invention the mean diffusion path denotes the mean value of the shortest spacings from each point of the surface of the core through the active material to the inside wall of the tube portion of the tube pocket, that surrounds the core. When the core is of a circular cross-section the shortest spacing from each point of the surface of the core to the inside wall of the tube portion is always constant and equal to the radius of the tube portion minus the radius of the cross-section of the core.

With the present invention the cross-section of the core is characterized by convex and concave portions so that the shortest spacing from a point on the surface of the core to the inside wall of the tube portion does not always necessarily extend radially from the center axis of the tube portion or the core. When a core involves a cross-sectional profile in accordance with the present invention there are diffusion paths from the surface of the core, which are shorter, and those which are longer, than the diffusion paths of a core of circular cross-section and of the same cross-sectional area. In relation to the overall periphery of the core the diffusion paths with the surface profile according to the invention are on average shorter than the diffusion paths of a circular surface profile of the same cross-sectional area. Such a reduction in the mean diffusion paths or current paths from the core surface through the active material reduces the resistance and thus the voltage losses in comparison with a core of circular cross-section. That effect, in conjunction with the reduction in current density, also contributes to increasing the utilization of material and thus an increase in capacity.

The form of the cores according to the invention does not have any detrimental effect on the processes applied such as casting of the tube plates, filling with active material and formation.

Further advantages, features and variants of the present invention are described hereinafter by means of embodiments by way of example and with reference to the accompanying Figures.

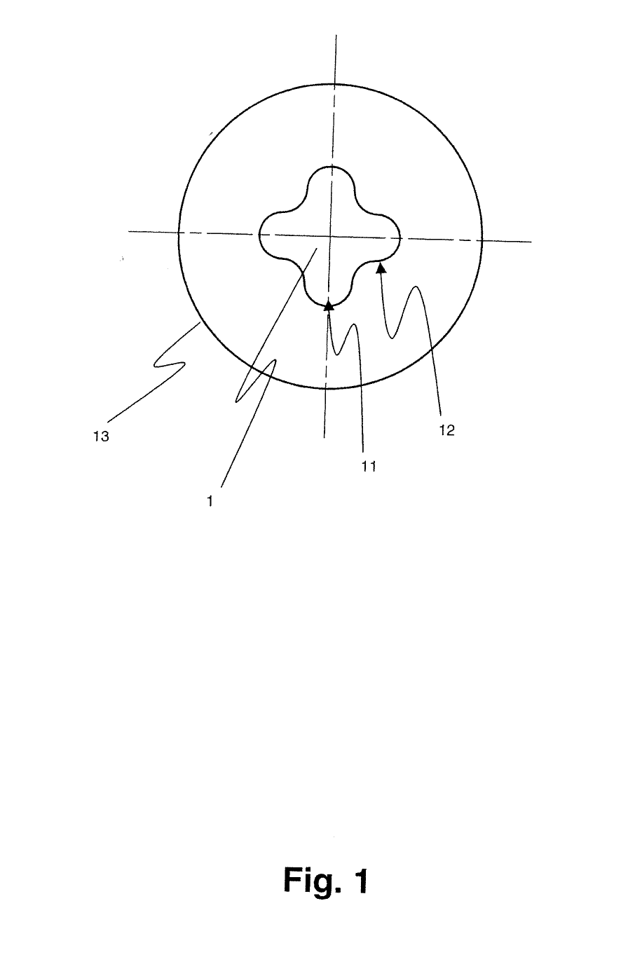

FIG. 1 shows the surface profile of a core according to the invention in cross-section in relation to its longitudinal extent and a cross-section of the associated tube portion of a tube pocket,

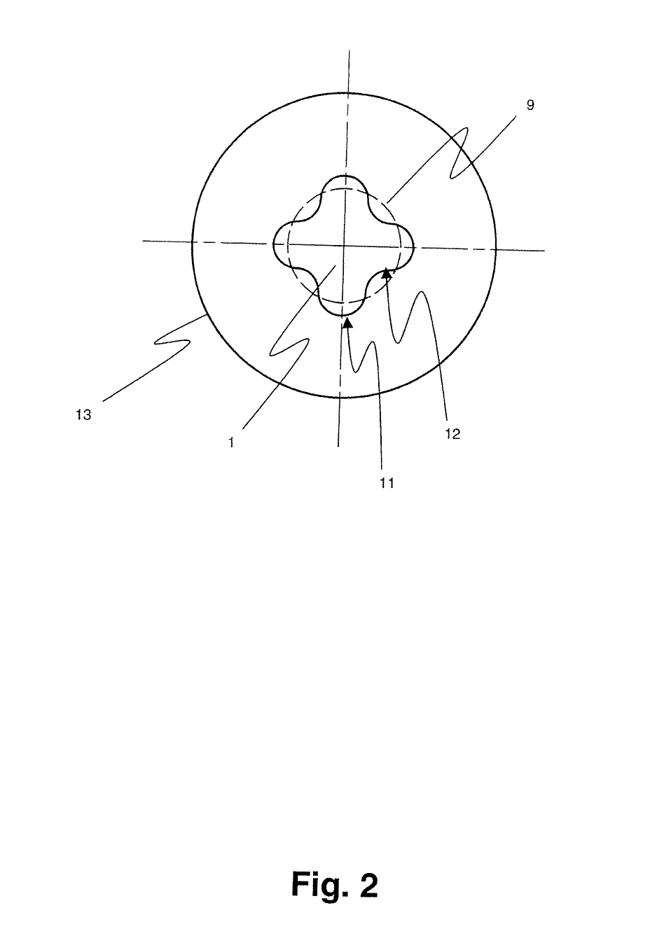

FIG. 2 shows the same view as FIG. 1 and in addition the surface profile of a core which is of circular cross-section, with the same cross-sectional area,

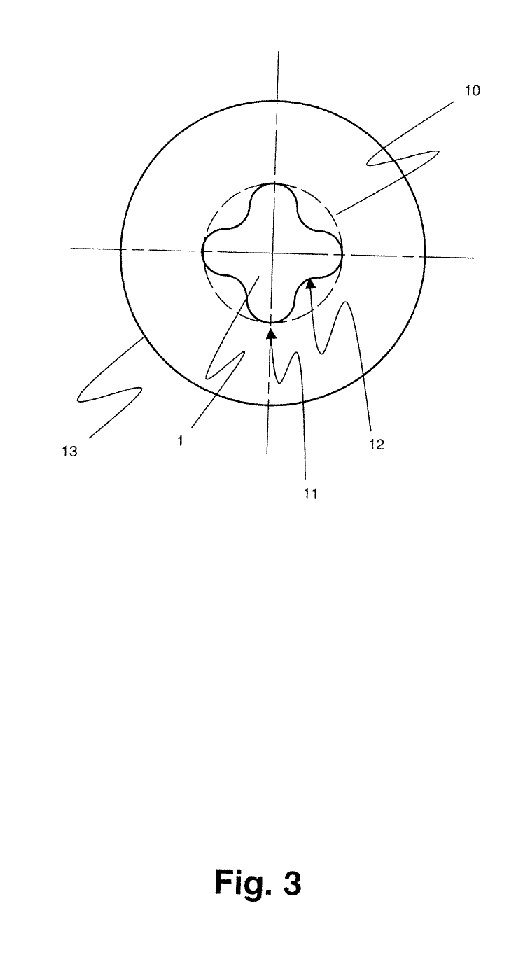

FIG. 3 shows the same view as FIG. 1 and in addition the surface profile of a core which is of circular cross-section and with a larger cross-sectional area than the core according to the invention, wherein the circular core however is of the same periphery as the illustrated core according to the invention,

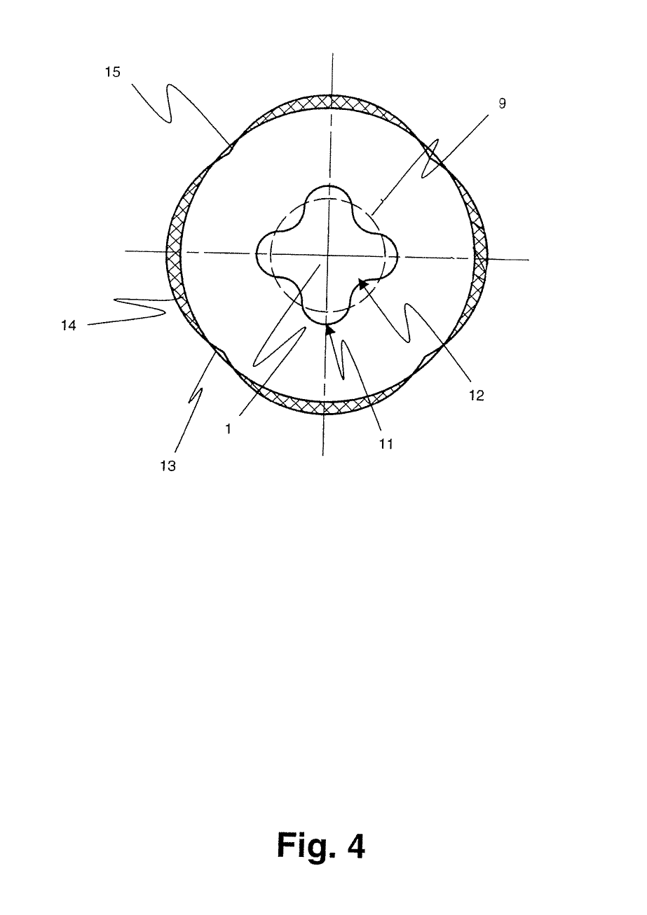

FIG. 4 shows essentially the view of FIG. 2 with the surface profile of the core according to the invention and a core of circular cross-section and of the same cross-sectional area and in addition the deviations of the diffusion paths between the core according to the invention and the circular core,

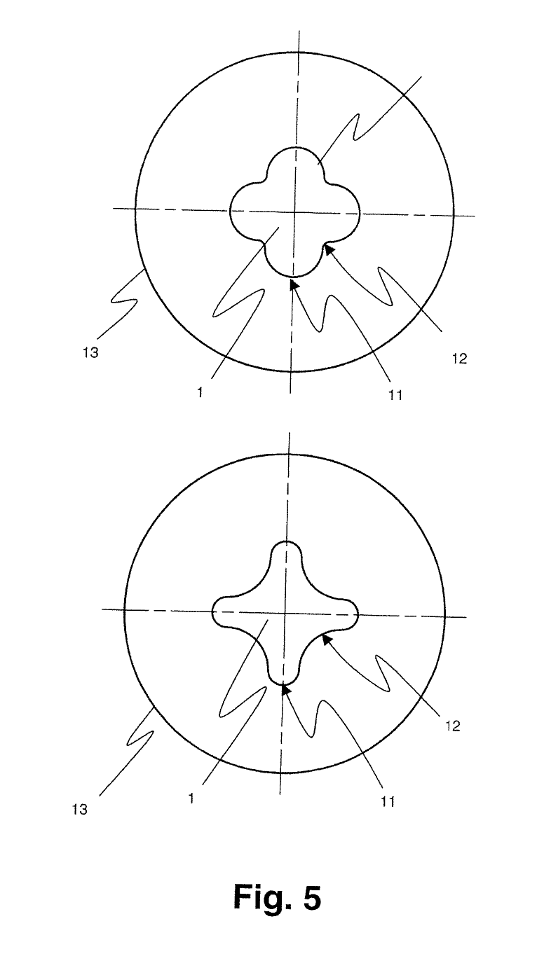

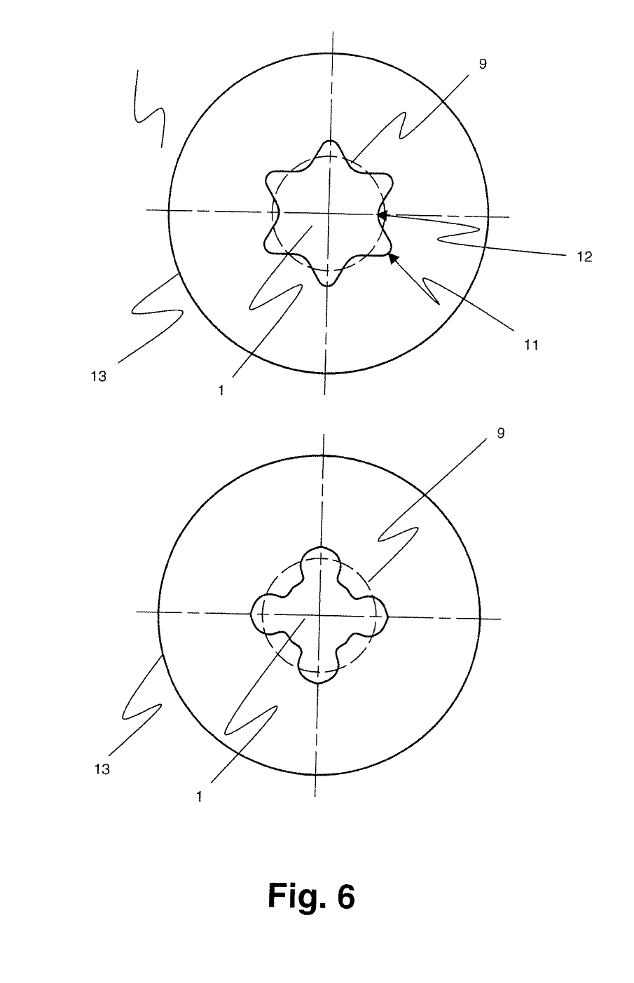

FIGS. 5 and 6 show four further embodiments of the surface profiles of cores according to the invention, and

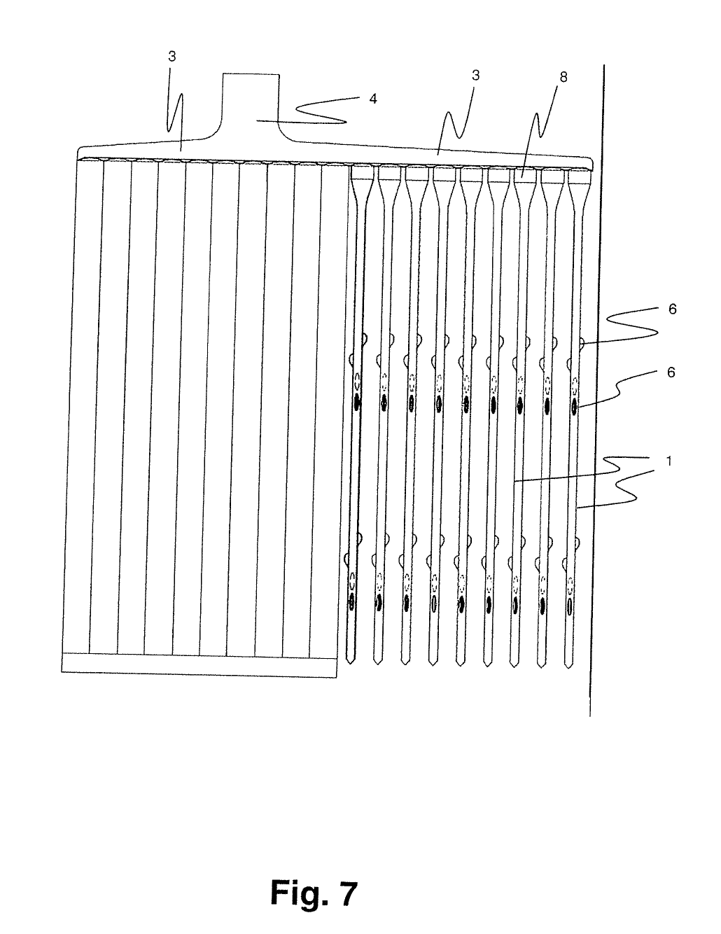

FIG. 7 shows a positive tube plate with an upper frame, the cylindrical and conical portions, the lug, the cores with spacers, the tube pockets and the closure bar.

FIGS. 1 through 4 show a core 1 according to the invention in cross-section relative to its longitudinal extent with a surface profile having four convex portions 10 and four concave portions 11, wherein in this embodiment the convex and concave portions 10 and 11 have the same radius each of 0.61 mm and the cross-sectional profile is therefore substantially cross-shaped and symmetrical. The Figures also diagrammatically show the inside wall 13 of a tube portion of a tube pocket in which the core extends. FIGS. 2 and 4 also show in broken line the surface profile of a core of circular cross-section and of the same cross-sectional area as the core according to the invention. The radius of the circular core 12 is 1.5 mm and the cross-sectional area of the circular core and the core according to the invention is here 7.1 mm².

The circular core shown in broken line in FIG. 3 has a radius of 1.83 mm, a periphery of 11.5 mm and a cross-sectional area of 10.5 mm². In comparison with the star-shaped embodiment according to the invention as is also shown in FIG. 3, that signifies an increase in the cross-section by 48% with the same periphery for both embodiments. In other words, that means that the star-shaped embodiment according to the invention, with the same periphery, has a correspondingly smaller cross-sectional area and thus with the same periphery requires markedly less material and thus involves a considerable saving in material cost. In addition, in comparison with the illustrated circular core, the embodiment according to the invention provides a considerably greater free space between the core surface and the inside of the tube portion, which can be filled with additional active material and thus provides an increase in capacity.

FIG. 4 further shows in hatching in this view filled regions 14 outside the diagrammatically illustrated inside wall of the tube portion 13 and regions 15 within the outside wall of the tube portion 13. The inside diameter of the tube portion 14 is 8.4 mm and therefore is of a radius of 4.2 mm. The diffusion path or current path from each point of the surface of the core 12 of circular cross-section is thus 4.2 mm−1.5 mm=2.7 mm.

The regions 14 and 15 shown in FIG. 4 or the outer boundary thereof is a projection of the diffusion path of the core 12 of circular cross-section of 2.7 mm onto the surface of the illustrated core 1 according to the invention to the inside wall of the tube portion 13. It is to be noted that in this case the radius was not always placed radially outwardly from the center point, but in the direction in which, from a given surface point of the core according to the invention, the path to the inside wall of the tube portion 13 is at the shortest.

In the projection shown in FIG. 4 the radii of the core of circular cross-section, when that is applied to the surface of the core according to the invention, extend predominantly to beyond the inside wall of the tube portion 13, shown by the hatched regions 14. The greater the regions 14 which are disposed outside the tube portion 13, in relation to the inwardly disposed regions 15, the correspondingly shorter is the mean diffusion path or current path of the core according to the invention in relation to the core of circular cross-section in accordance with the state of the art.

In the embodiment of FIG. 4 the periphery of the surface profile of the core of circular cross-section in accordance with the state of the art is 9.4 mm whereas the periphery of the surface profile of the illustrated core according to the invention is 11.5 mm. Accordingly the ratio of the periphery of the core according to the invention to the periphery of the circular core is 122%, which also corresponds to the ratio of the respective surface areas. The larger surface area of the core according to the invention results in a current density at the surface, that is less by 20%, and thus gives an increased utilization of material.

At the same time the projection in FIG. 4 shows that a markedly shorter mean diffusion path or current path from the surface of the core through the active material to the tube portion of the tube pocket is achieved by the surface profile according to the invention in comparison with a surface profile of circular cross-section with the same cross-sectional area and thus the same material consumption. In that way the resistance through the active material is lower and the voltage loss is reduced.

FIG. 5 shows two variants of the surface profile of the core shown in FIGS. 1 through 4 with also four convex and four concave portions, wherein the convex portions and the concave portions are each of the same radii relative to each other but convex portions have different radii from concave portions. In the core as shown in FIG. 5 at the top the radius of the convex portions is 0.75 mm and of the concave portions is 0.2 mm. In the core in FIG. 5 at the bottom the radius of the convex portions is 0.4 mm and the concave portions is 1.1 mm. The cross-sectional area of both core profiles as shown in FIG. 5 is about 7.1 mm and thus corresponds to the cross-sectional area of the core according to the invention as shown in FIGS. 1 through 4 and the core shown in FIGS. 2 and 4 in accordance with the state of the art of circular cross-section and of a radius of 1.5 mm. In comparison with the core of cross-section, which has a periphery for the surface profile of 9.4 mm, the periphery of the surface profile of the core shown at the top in FIG. 5 is 10.7 mm and the periphery of the surface profile of the core shown at the bottom in FIG. 5 is even 14.3 mm, which is markedly above the periphery of the core according to the invention as shown in FIGS. 1 through 4 of 11.5 mm.

FIG. 6 shows two further embodiments of cores according to the invention, wherein the core at the top in FIG. 6 has six convex portions of a radius of 0.25 mm and six concave portions of a radius of 0.5 mm, has a cross-sectional area of 7.9 mm² and has a periphery for the surface profile of 12.6 mm.

### LIST OF REFERENCES

1 core

2 tube plate

3 upper frame

4 lug

5 closure bar

6 spacer (blade portion)

7 tube pocket

8 cylindrical portions between upper frame and core

9 circular core of equal cross-sectional area

10 circular core with equal periphery

11 convex portion

12 concave portion

13 inside wall of tube portions of the tube plate

14 outwardly disposed regions

15 inwardly disposed regions

1. A tube plate for an electrode, preferably a positive electrode, of a lead acid battery, wherein the tube plate (2) has an upper frame (3) and a plurality of lead or lead alloy cores (1) extending substantially parallel from the upper frame (3), characterized in that in the cross-section relative to their longitudinal extent the cores (1) have a surface profile with at least three convex portions (11) and at least three concave portions (12), wherein convex and concave portions (11, 12) alternate in the course of the surface profile.

2. A tube plate as set forth in claim 1 characterized in that straight portions are provided between convex and concave portions (11, 12) in the course of the surface profile.

3. A tube plate as set forth in one of claims 1-2 characterized in that straight portions are provided within convex and concave portions (11, 12) in the course of the surface profile.

4. A tube plate as set forth in one of claims 1-2 characterized in that all convex portions (11) in the course of the surface profile are of the same radius or the same radius configuration and/or all concave portions (12) are of the same radius or the same radius configuration in the course of the surface profile.

5. A tube plate as set forth in one of claims 1-2 characterized in that all convex portions (11) have precisely one radius in the course of the surface profile and/or all concave portions (12) have precisely one radius in the course of the surface profile.

6. A tube plate as set forth in one of claims 1-2 characterized in that the convex portions (11) are of the same radius or the same radius configuration in the course of the surface profile as the concave portions (12) but in the opposite direction of curvature.

7. A tube plate as set forth in one of claims 1-2 characterized in that the surface profile of the cores (1) has between 3 and 6 convex and between 3 and 6 concave portions (11, 12), preferably between 3 and 5 convex and 3 and 5 concave portions (11, 12), and quite particularly preferably four convex and four concave portions (11, 12) which alternate in the course of the surface profile.

8. A tube plate as set forth in one of claims 1-2 characterized in that the radii of the convex and concave portions (11, 12) of the surface profile of the cores (1) are in the range of between 0.1 and 1.5 mm, preferably between 0.2 and 1.1 mm, further preferably between 0.3 and 0.9 mm, particularly preferably between 0.4 and 0.8 mm.

9. A tube plate as set forth in one of claims 1-2 characterized in that the transitions from the upper frame (3) to the cores (1) are respectively formed by portions (8) which initially extend cylindrically from the upper frame and taper conically towards the cores (1).

10. A tube plate as set forth in one of claims 1-2 characterized in that the plurality of cores (1) extending substantially parallel from the upper frame (3) are substantially equidistant.

11. A tube plate as set forth in one of claims 1-2 characterized in that there is further provided a tube pocket (7) having a number, corresponding to the number of cores, of mutually juxtaposed tube portions of substantially circular or oval cross-section, preferably circular cross-section, and of a length greater than the length of the cores (1).

12. A tube plate as set forth in one of claims 1-2 characterized in that the tube pocket (7) is made from a textile material, preferably a textile woven material or non-woven material.

13. A tube plate as set forth in claim 9 characterized in that the tube portions of the tube pocket (7) are of a diameter which substantially corresponds to the diameter of the portions extending initially cylindrically from the upper frame (3) so that the tubes of the tube pockets (7) can be brought substantially in force-locking relationship into engagement with the cylindrical portions.

14. A tube plate as set forth in one of claims 1-2 characterized in that there are provided at least two and preferably between 3 and 12 spacer portions projecting substantially perpendicularly to the longitudinal axis of the cores (1) and holding the cores at a spacing relative to the inside wall of the tube portions of the tube pocket.

15. A lead acid battery having tube plates (2) as set forth in one of claims 1-2 as preferably positive electrodes.
